(19) United States
(12) Patent Application Publication
(10) Pub. No.: US 2024/0173894 A1
(43) Pub. Date: May 30, 2024

(54) A DEVICE AND A METHOD FOR THE HEAT TREATMENT OF THERMOPLASTIC MELTS

(71) Applicant: STARLINGER & CO GESELLSCHAFT M.B.H., Wien (AT)

(72) Inventors: Markus FELLINGER, Wien (AT); Gerhard BRÄUER, Wien (AT)

(21) Appl. No.: 18/551,371

(22) PCT Filed: Mar. 9, 2022
(86) PCT No.: PCT/EP2022/056106

§ 371 Date: Sep. 19, 2023

(30) Foreign Application Priority Data
Mar. 26, 2021 (EP) 21165119.5

(51) Int. Cl. B29B 7/74; B29B 7/48; B29B 7/58; B29B 7/84

(52) U.S. Cl. CPC B29B 7/7461; B29B 7/481; B29B 7/58; B29B 7/845

(57) ABSTRACT

The device for treating melts of thermoplastics has a housing in which first and second rotatably driven shafts are disposed, a plurality of mixing elements being axially spaced on each shaft. The mixing elements of the first shaft are axially offset from the mixing elements of the second shaft so that they face gaps between the mixing elements of the second shaft. The mixing elements of the second shaft are axially offset from the mixing elements of the first shaft so that they face gaps between the mixing elements of the first shaft. The distance (A) of the first and second shafts from each other and the greatest radial lengths (R) of the mixing elements are dimensioned so that the mixing elements engage in the spaces opposite them.

The present invention relates to a device for the heat treatment of thermoplastic melts according to the preamble of claim 1 and to a method for the heat treatment of thermoplastic melts according to the preamble of claim 14 or 17.

The invention is generally based on the task of providing a reliable, cost-effective and robust heat treatment device for thermoplastic melts for various applications, in which the plastic melt to be treated remains in the heat treatment device for a defined dwell time at a defined temperature.

It has been known that volatile substances may be present in plastic melts, which are released from the melt in the course of a heat treatment. These may be impurities, e.g. from recycling processes, by-products from melting the plastic that were not originally present as molecules in the plastic, substances that are transferred from the filling material to the plastic material during use, or by-products that are developed by a reaction in the plastic material.

The invention thus relates generally to the efficient removal of volatile substances from thermoplastic melts in various fields of application.

A possible field of application of the invention for the removal of volatile substances from a thermoplastic melt is the broad field of application of plastics recycling. Plastics may be contaminated by foreign substances during their use, for example when products are filled into plastic packaging and migration from the filling material leads to contamination of the packaging. An example of this is the migration of toluene, which is present in hair shampoo, into the packaging (e.g. PP hollow body) of the hair shampoo. Furthermore, in the recycling cycle, misuse of the packaging after the original filling material has been emptied, e.g. if someone fills a petrol-lubricating oil mixture in a ratio of 1:25 or 1:50 into a plastic beverage bottle, may lead to contamination of the packaging. In order to be able to use such contaminated containers again for food packaging, the European Food Safety Administration (EFSA) and the American FDA (Food and Drug Administration), for example, specify fundamental limits for contamination, below which a plastic material that has already been used by the consumer is permissible again as food packaging. It must be ensured, however, that these limits are reliably undercut by the recycling company and the recycling process used.

Furthermore, in recycling, the high-temperature treatment of the plastic material under pressure and temperature may lead to degradation products from various chemical reactions. For example, during the extrusion of PET, acetaldehyde may be developed as a volatile substance, which in turn may lead to unwanted changes in the taste of a beverage when it is stored for a longer period of time in a recycled PET bottle. Odour reduction of aromatic substances in the plastic melt is also possible (see below).

All these volatile substances must be reduced to below the legal limit during the recycling process.

A further field of application of the invention is the reduction of e.g. aromatic substances from the plastic melt, which either enter the plastic material in the form of additives due to the initial addition of these substances during the manufacturing process, or are developed by chemical reactions of various substances during the manufacturing process or as degradation products of the plastic material. These substances are emitted during the use of the plastic material, constituting an odour nuisance for some people or, in the worst case, being toxic. It is therefore desirable to reduce such aromatic substances to an absolute minimum already during the manufacturing process. One example of this is the odour of a new car.

The melt polycondensation of polycondensates, such as PET, PC or PA, also represents a possible field of application of the present invention. In the polycondensation of PET, mainly ethylene glycol and water are cleft under high temperature in the melt phase of PET when two molecular chains are joined to form a longer molecule. These separation products must be reliably and quickly removed from the polycondensate melt in order to increase the viscosity of the polycondensate melt.

The present invention may also be used for a combination of the three fields of application mentioned above. For example, it is possible to decontaminate recycled PET from bottles or foil waste by means of the invention and thus to purify it from foreign substances, to increase the viscosity of the melt by means of melt phase polycondensation in the same work step and to remove any aromatic substances at the same time.

In one aspect, the invention relates to a device for treating melts of thermoplastic materials, in which plastic melt is continuously transported from the inlet to the outlet and, optionally, is simultaneously degassed and thus purified from volatile substances by applying a negative pressure.

Such devices are known, for example, from DE 10 2018 216 250 A1 or AT 516967 A1.

In both known devices, the polycondensation melt is conveyed from the inlet to the outlet by means of discs or mixing elements rotatably mounted in a housing, and the immersion of the mixing elements creates a surface, to which the melt will temporarily adhere. Both devices function more reliably the thinner the melt. However, if the toughness of the melt increases as the degree of polycondensation of the melt increases, the plastic melt will stick to the mixing elements, which means that a constant dwell time of the melt in the reactor is no longer being ensured, as there is no forced conveying of the polycondensation melt due to the design. In the worst case, coking may occur if the plastic melt sticks to the mixing elements for several hours. After detachment from the mixing elements, this coking leads to an unusable product.

Furthermore, twin-screw extruders or kneaders have been known, in which two extrusion screws intermesh and run in the same direction or in opposite directions, thus shearing each other off and making it impossible for the melt to adhere. However, such extruders require very precise manufacture of the screw elements and cannot be used economically for the intended fields of application of the invention, if only because of the relatively long dwell times of the melt in the reaction chamber aimed at according to the invention and the associated manufacturing costs. Such a twin-screw extruder has been known from WO 2018/215028 A1.

Furthermore, multi-screw reaction extruders have been known from WO 03033240 A1 and WO 2020/099684 A1, which, however, cannot be used economically for the dwell times aimed at according to the invention due to their design.

The heat treatment device for plastic melts disclosed in the DE 102018216250 A1 mentioned above is a disc reactor, in which several discs, offset in the axial direction and mounted on a drive shaft, rotate within a cylindrical tube. In this case, the filling level of the tube with plastic melt is limited to a maximum of half of the volume. Due to the discs rotating and immersing in the plastic melt, part of the plastic melt is drawn upwards with the discs and exposed to a underpressure in the melt-free space at the surface. As a result, volatile components of the plastic melt, such as in the case of PET mainly ethylene glycol or water in the form of water vapour, migrate out of the plastic melt and are transported off by the negative pressure prevailing at the opening. However, the plastic melt to be processed may also contain other undesired volatile components, such as aromatics or other chemicals, which are either produced during the manufacture of the plastic substance or during melting as reaction products due to temperature and/or pressure of the various plastic components, or which migrate as impurities during the use of a plastic product or during the purification of plastic waste into the plastic material prior to re-melting. e.g. cleaning agents or washing additives. Such impurities are an unwanted evil especially when using recycled plastics due to odour pollution or toxic contamination. e.g. in food packaging.

The disadvantages of conventional melt-phase or disc reactors in a cylindrical tube are in particular that the use of such reactors is limited to “low-viscosity” plastic melts. This is due to the fact that the surface is only renewed when the discs are immersed in the plastic bath, whereas viscous melts stick to the discs, which may lead to undefined dwell times of the plastic melt in the reactor and even to so-called coking of the plastic melt. This is a major problem, for example, in the processing of PET, where such reactors are used as melt phase polycondensation reactors and the plastic melt at the inlet is at an intrinsic viscosity according to ASTM D445. DIN EN ISO 1628-5 of 0.2-0.65 dl/g and in commercial applications is limited to an outlet viscosity of approx. 0.75-0.8 dl/g. With higher viscosity plastic materials and with PET >0.8 dl/g, the discs stick together, which, in addition to the coking that occurs after some time, also reduces the surface area of the plastic melt and thus one of the decisive factors for the migration of the volatile components from the melt. Another problem with these melt reactors is dead spaces between the discs or in the feed and discharge area, where again undefined dwell times and material damage of the melt may occur. In addition to the disadvantages described above, it is also very unsatisfactory to run such a reactor empty in the case of viscous melts, since the continuous cleaning of the discs by fresh melt is not possible. In order to circumvent the problems of running the reactor empty, prior art devices for batch-wise polycondensation of polymers have been designed, as proposed in WO 2008/043548 A1. However, this approach is also unsuccessful for viscous melts. On the other hand, it even creates additional problems when starting with a fresh melt batch in order to bring it to a uniform temperature in the reactor. For the treatment of highly viscous plastic melts in a reactor, it was proposed in WO 2006/050799 to form chambers in a cylindrical vessel in the area of the melt sump by means of partition walls, in which annular discs serve as stirring elements and are attached to a shaft by means of spokes, wherein scrapers are arranged in the spaces between the annular discs, which are arranged opposite each other and are connected stationarily to the inside of the vessel. Similar concepts with rotating discs and stationary scraper elements arranged in-between are also known from the above-mentioned DE 10 2018 216 250 A1 as well as WO 2007/140926 A1 and EP 0) 320 586 B1. Even though these devices may solve the problem of coking of plastic melt adhering to the discs, they cannot ensure a defined dwell time of high-viscosity plastic melt and also have the disadvantage of low performance due to insufficient surfaces of the high-viscosity plastic melt forming on the discs.

The present invention aims at improving the disadvantages described above of single-shaft disc reactors and at providing a more cost effective and reliable device for decontamination of new and recycled plastics, such as HDPE, LDPE, LLDPE, PP, PS, PA, and PET, among others, with MFI values in the melt from 0.1 g/10 min for HDPE up to 1000 g/10 min for PP according to DIN EN ISO 1133 (MFI measurement), respectively, or for the decontamination and polycondensation of polycondensates such as PA, PEN or PET, with intrinsic viscosity values of the melt on entry into the heat treatment reactor of 0.2-0.75 dl/g and intrinsic viscosity values of the melt on exit from the heat treatment reactor of 0.6-1.2 dl/g. Furthermore, the invention proposes a method for the heat treatment of thermoplastic melts, using which the problems of the prior art mentioned at the beginning may be overcome.

The present invention solves the task posed by a device for treating melts of thermoplastics having the features of claim 1 and by a method for treating melts of thermoplastics having the features of claim 14 and claim 17. Advantageous embodiments of the invention are set forth in the sub claims as well as in the following description and the drawings.

The device according to the invention for treating melts of thermoplastics has a housing with a melt inlet opening, a melt outlet opening and a withdrawal opening for volatile components of the plastic melt. This device comprises at least a first rotatably driven shaft and a second rotatably driven shaft, wherein a plurality of mixing elements is arranged on each shaft axially spaced apart from one another and rotating with the shaft. The mixing elements of the first shaft are axially offset from the mixing elements of the second shaft such that the mixing elements of the first shaft face spaces formed between the axially spaced mixing elements of the second shaft. The mixing elements of the second shaft are axially offset from the mixing elements of the first shaft in such a way that the mixing elements of the second shaft face interstices formed between the axially spaced mixing elements of the first shaft, wherein the distance of the first and second shafts from each other and the greatest radial lengths of the mixing elements are dimensioned in such a way that the mixing elements engage in the interstices facing them.

This design of the device for treating melts of thermoplastics ensures, on the one hand, that the thermoplastics may form a large surface on the mixing elements and therefore the discharge of undesired substances from the plastic melt may proceed quickly. On the other hand, it also reliably prevents uncontrolled long dwell times of the plastic melts on the mixing elements and thus undefined viscosity increases or even coking of the plastic melt adhering to the mixing elements.

In a preferred embodiment of the device according to the invention, the axial thicknesses of the mixing elements are dimensioned in such a way that they form a gap of between 0.5 and 5 mm when engaging in the interstices with the mixing elements defining the interstices. As a result, reliable shearing off the plastic melt from the surfaces of the mixing elements is achieved without placing excessively high demands on the manufacturing accuracy and thus on the manufacturing costs of the device according to the invention.

In order to form the interstice between the mixing elements, there is provided in one embodiment of the invention that the axial distances of the mixing elements are defined by arranging spacers between the mixing elements, wherein the spacers have a smaller radial extent than the mixing elements. The spacers may be configured as discs that may be pushed onto the respective shaft and are preferably replaceable.

In order to further improve the shearing off of plastic melt from the mixing elements, there is provided in one embodiment of the device according to the invention that the greatest radial lengths of the mixing elements are dimensioned in such a way that, when they engage in the interspaces, they are at a distance of 0.5 to 5 mm from the circumferential surface of the shaft opposite to them or from the circumferential surface of any spacers arranged on the shaft opposite to them.

A structurally simple design of the device according to the invention will be the result if the first and second shafts are aligned in parallel to each other.

It has been shown that the dwell time of the plastic melt and the discharge of undesired substances from the plastic melt may be controlled particularly well if the mixing elements are configured as blade elements having at least two blades or as discs.

In order to achieve a transport effect of the plastic melt towards the melt outlet opening, it is preferable that the mixing elements are provided with chamfers on their peripheries. Although this measure is not a real forced conveying, the effect of the chamfers is comparable to a forced conveying of the plastic melt.

In order to achieve a large variability of the device according to the invention depending on the type of plastic to be treated and the field of application, according to the invention the first and the second shaft may be designed to be rotatable in the same direction or in opposite directions at different speeds, wherein, in addition or as an alternative, the first and/or the second shaft may be reversible in its direction of rotation.

In a preferred embodiment of the device according to the invention, the first or/and the second shaft are axially displaceable, wherein the displacement is preferably a pulsating one. A common axial displacement of the first and the second shaft serves to scrape off the front-face inner walls of the housing. A slight axial displacement of one of the two shafts or an opposite displacement of the two shafts in relation to each other serves to change the gap widths in the interstices.

For supporting the melt transport to the melt outlet opening of the housing, there may be provided according to the invention that in the bottom area inside the housing of the device there is formed a screw conveyor between the mixing elements of the first shaft and the mixing elements of the second shaft.

In a further embodiment of the device according to the invention, the housing and/or at least one of the shafts may be temperature-controlled, i.e. heated or cooled, in order to ensure the optimum temperatures for the treatment of the plastic melt inside the device in each case. Heating may be realized by way of electrical heating elements or temperature control medium lines installed in or around the walls of the housing and/or in the shafts, cooling may be realized by way of said temperature control medium lines.

The method according to the invention for the heat treatment, preferably for the decontamination, of melts of thermoplastic materials in a heat treatment device having a housing with a melt inlet opening, a melt outlet opening and a withdrawal opening for volatile components of the plastic melt, which may be connected to a vacuum, is characterized by allowing the melt to remain in the heat treatment device for a heat treatment time of 1-120 min at a heat treatment temperature above the melt temperature of the plastic to be treated and optionally a vacuum between 0.1 and 900 mbar, preferably between 1 and 10 mbar. It would also be conceivable to flush the heat treatment device by means of air or a gas and thus transport volatile components out of the container. Furthermore, it would be conceivable to put the heat treatment container under overpressure (e.g. by means of an inert gas such as nitrogen or CO₂) and thus stimulate the plastic melt to form bubbles (foaming) or to mix the plastic melt with gas and force the plastic to expand after it has cooled down by means of reheating, respectively.

To carry out this process, the device according to the invention explained above may be used for treating melts of thermoplastic materials.

The invention is explained in greater detail below by means of embodiment examples with reference to the drawings.

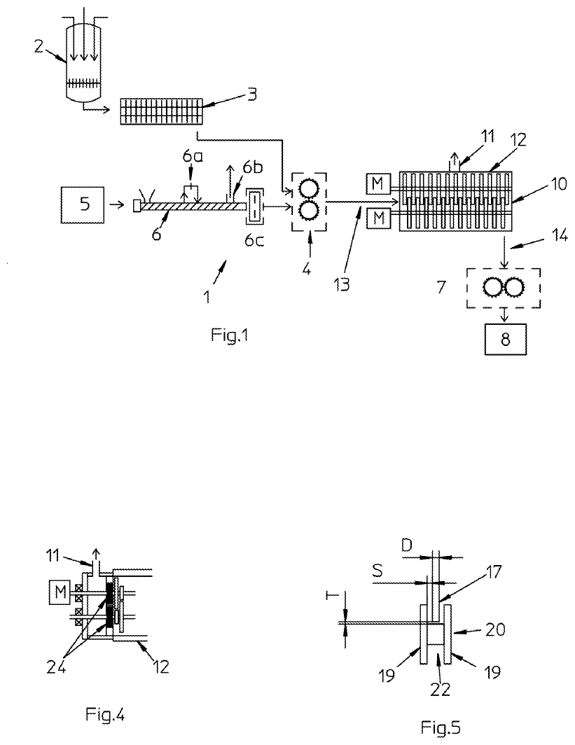

FIG. 1 schematically shows a plant for processing thermoplastic melts with a device according to the invention for treating melts of thermoplastics.

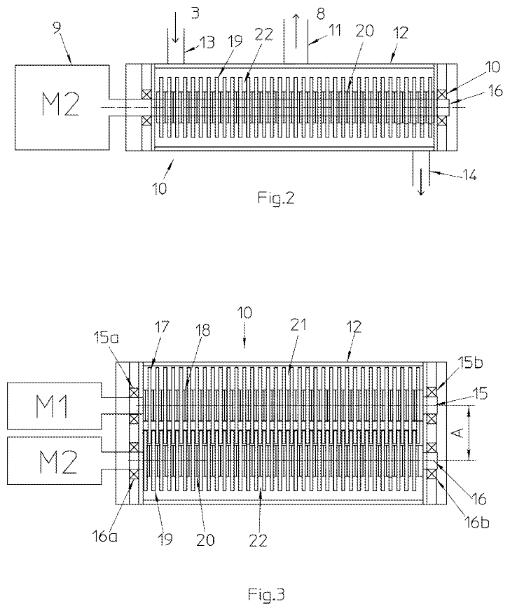

FIG. 2 shows a schematic side view of a first embodiment of the device according to the invention for treating melts of thermoplastic materials.

FIG. 3 shows a schematic top view of the first embodiment of the device according to the invention for treating melts of thermoplastic materials.

FIG. 4 shows a detail of a variant of the device according to the invention for treating melts of thermoplastic materials.

FIG. 5 shows a further detail of the device according to the invention for treating melts of thermoplastic materials.

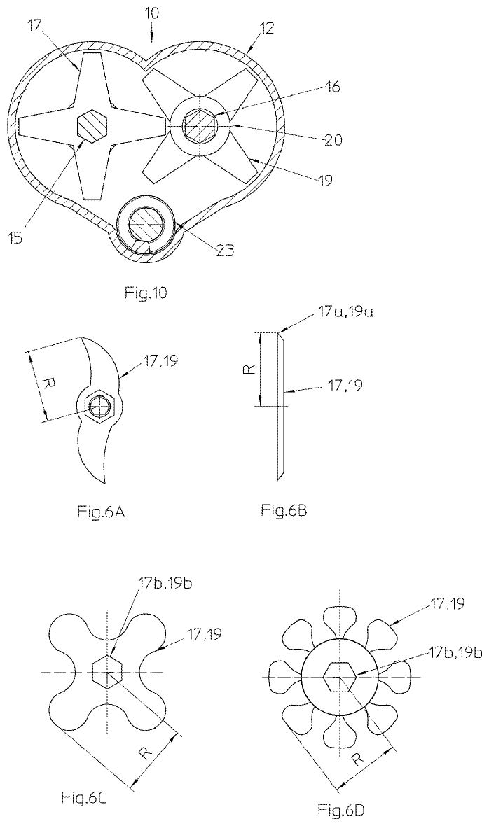

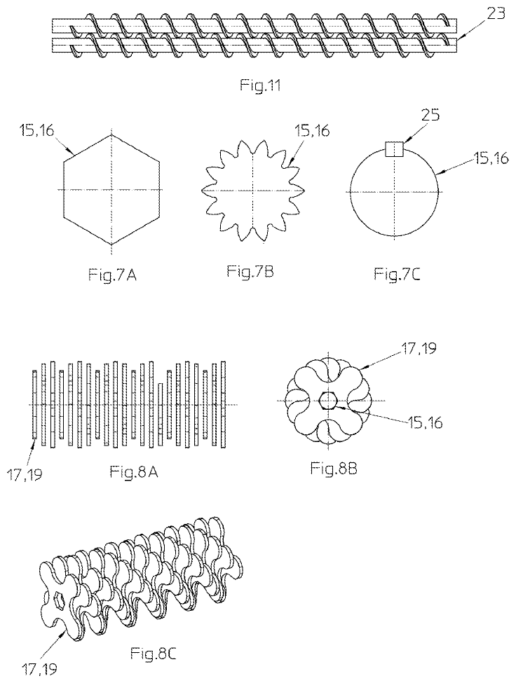

FIGS. 6A to 6D show various embodiments of the mixing elements used in the device according to the invention.

FIGS. 7A to 7C show different cross-sectional shapes of the shafts used in the device according to the invention.

FIGS. 8A, 8B, 8C show an arrangement of the mixing elements configured as blades on the shaft 15, 16 in the form of a helix in side view, front view and in perspective.

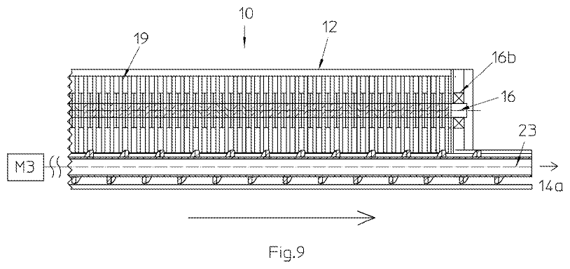

FIG. 9 shows a second embodiment of the device according to the invention for treating melts of thermoplastic materials in a cross-sectional view.

FIG. 10 shows a longitudinal sectional view of the second embodiment of the device according to the invention for treating melts of thermoplastic materials.

FIG. 11 shows a twin screw for use in the second embodiment of the device according to the invention for treating melts of thermoplastics.

With reference to FIG. 1, a plant for processing thermoplastic melts is first explained, in which the device 10 according to the invention for treating melts of thermoplastics is used and in which the method according to the invention for heat treatment, preferably decontamination, of melts of thermoplastics is carried out.

This exemplary plant 1 is suitable both for the use of new plastic material and for the processing of plastic waste, in particular post-consumer plastic waste, and also for the joint processing of new plastic material and plastic waste. Some of the plant components described are optional, other plant components may be replaced by other devices.

In a first plant branch, the plant 1 for processing plastic material comprises a plastic production reactor 2, to which plastic raw material and additives are fed, which are mixed with each other in the plastic production reactor 2. The starting product of plastic material may be present in the form of raw materials such as PET from PTA. EG and catalysts such as antimony.

The mixture of plastic raw material and additives is fed to a melt phase reactor 3, in which it is homogenised and, for example in the case of PET, polycondensed. The plastic melt homogenised in this way is fed to a first inlet of a melt pump 4.

The plant 1 for processing plastic material also comprises a second branch, which is adapted for processing plastic waste. This second branch comprises a schematically shown pre-treatment device 5, in which the plastic waste is prepared for further processing. The steps carried out in the pre-treatment facility comprise, for example, washing, intensive cleaning, pre-drying and comminution of the thermoplastic waste. After the pre-treatment has been completed, the plastic waste is fed into an extruder 6, in which the plastic waste is melted. The extruder 6 may be a single-screw extruder, a twin-screw extruder with co-rotating or counter-rotating screws, or a conical twin-screw extruder or multi-screw extruder. The extruder 6 may be provided with a first filter device 6a, in which foreign particles are filtered out of the plastic melt. The extruder 6 may be provided with a degassing device 6b comprising an opening for discharging volatile components from the plastic melt. In this process, the plastic melt is first placed in a substantially pressureless state, and volatile components of the plastic melt, such as monomers, water or—in the case of PET—ethylene glycol, are withdrawn, optionally by means of a vacuum generator. Optionally, a second filter device 6c is arranged at the outlet of the extruder 6, which filters out any foreign particles still contained in the plastic melt. The second filter device 6c may also be provided instead of the first filter device 6a. In the case of these filter devices, all commercially available devices are suitable, such as continuous or discontinuous wire mesh filters with or without a backflushing device. From the outlet of the extruder 6 or the second filter device 6c, respectively, the thus homogenised, cleaned and filtered melt of plastic waste is fed to a second inlet of the melt pump 4. The melt pump 4 forms a forced conveying system for the plastic melts by generating pressure. The melt pump 4 also constitutes a mixing device for the plastic melt streams in case both branches of the plant 1 are fed with plastic material or plastic waste. It is also possible to provide a separate melt pump at the end of each branch and then feed the plastic melt streams to a mixer after the outputs of the melt pump. As known in prior art, the melt pump 4 may be configured as a gear pump. Alternatively, an extension of the extruder screw may be used to generate pressure. As far as described so far, the plant 1 contains devices that are well known to those skilled in the art and therefore do not require a more detailed discussion.

From the melt pump 4, the plastic melt is fed, optionally with the interposition of a melt filter device, to a melt inlet opening 13 of the device 10 according to the invention for treating melts of thermoplastics, which is described in detail below. The volatile components of the plastic melt produced in the device 10 for treating melts of thermoplastics are discharged from the device 10 via a withdrawal opening 11. After heat treatment of the plastic melt in the device 10 for treating melts of thermoplastics, the plastic melt is guided from a melt outlet opening 14 of the device 10 to a discharge device 7, which may be a gear pump, for example. From the discharge device 7, the plastic melt passes into a schematically shown post-treatment device 8. This post-treatment device 8 may comprise different stations, e.g. shaping devices, such as a granulating device, a profile extrusion device, an injection moulding machine, round or wide slot dies for the production of sheets and foils, etc. In the post-treatment device 8, further method steps may be carried out, such as additivation of the plastic melt, for example with colours, or mixing devices. The post-treatment is not part of the invention.

In addition or alternatively to the processing already described of plastics or plastic waste and their feeding to the device 10 for treating melts of thermoplastics according to the invention, the plastic melt to be treated in the device 10 according to the invention may also be taken directly from a reactor for the production of new plastics and further treated in the device 10. The device 10 according to the invention for treating melts of thermoplastics may also be placed upstream or downstream of a melt phase reactor for pre- or further treatment of the plastic melt.

With reference to FIG. 2 and FIG. 3, a first embodiment of a device 10 according to the invention for treating melts of thermoplastic materials will now be explained in greater detail. This device 10 has a housing 12 with a melt inlet opening 13, a melt outlet opening 14 and a withdrawal opening 11 for volatile components of the plastic melt. The withdrawal opening 11 for volatile substances could also be arranged on the inlet side of the housing 12, as shown in FIG. 4, and/or on its outlet side. A first shaft 15 rotatably driven by a first electric motor M1 and a second shaft 16 rotatably driven by a second electric motor M2 are arranged in the housing 12. On each of the two shafts 15, 16, several mixing elements 17, 19 are arranged axially spaced apart from each other and rotating with the shaft 15, 16. The two shafts 15, 16 are connected to their respective drive motors M1, M2 via detachable connections, such as couplings or gears for transmitting the torque. The shafts 15, 16 have bearings 15a, 15b and 16a, 16b, respectively, which are sealed and protected, if necessary, depending on the application, via shaft sealing rings, return threads, stuffing boxes to protect against the ingress of plastic melt or dust and/or vacuum (not shown). The mixing elements 17, 19 are encased in their enveloping form by the housing 12. The housing 12 is configured in a way such that a gap of between 0.5 and 5 mm is formed between the inner wall of the housing 12 and the enveloping forms of the mixing elements 17, 19. The shafts 15, 16 are driven by the respective electric motors M1, M2 and, if necessary, intermediate gears with a speed between 1 rpm and 50 rpm. A configuration by means of a drive motor M (see FIG. 4) and a gearbox having two output drives (not shown) for the shafts 15, 16 is also conceivable. The mixing elements 17, 19, which are seated on the shafts 15, 16 in the front and in the end region, may in alternative embodiments of the device 10 be driven by a feed thread 24 (see FIG. 4) or a return feed thread on the shafts 15, 16, and withdrawal openings 11 for volatile substances may be located at the respective beginning of the feed thread 24, see FIG. 4. The housing 12 is heated, e.g. by heating by means of oil, infrared radiators or individual electric heating elements. The shafts 15, 16 may also be heated or, for certain applications, cooled.

The mixing elements 17 of the first shaft 15 are axially offset from the mixing elements 19 of the second shaft 16 in such a way that the mixing elements 17 of the first shaft 15 face interstices 22 formed between the axially spaced mixing elements 19 of the second shaft 16, and the mixing elements 19 of the second shaft 16 are axially offset from the mixing elements 17 of the first shaft 15 in such a way that the mixing elements 19 of the second shaft 16 face interstices 21 formed between the axially spaced mixing elements 17 of the first shaft 15. The distance A of the first and second shafts 15, 16 from each other and the greatest radial lengths R (see FIGS. 6A to 6D) of the mixing elements 17, 19 are dimensioned such that the mixing elements 17, 19 engage in the interstices 22, 21 opposite to them. In this embodiment example of the device 10 according to the invention, the first and second shafts 15, 16 are aligned in parallel to each other. However, they could also be at an angle to each other if the mixing elements 17 of the first shaft 15 and/or the mixing elements 19 of the second shaft 16 have different radial lengths R.

As depicted in FIG. 5, the axial thicknesses D of the mixing elements 17, 19 are dimensioned in such a way that they form a gap S with a width between 0.5 and 5 mm when they engage in the interstices 22, 21 with the mixing elements 19, 17 defining the interstices 22, 21. On the one hand, this dimensioning ensures that plastic adhering to the mixing elements 17, 19 is reliably sheared off and, on the other hand, allows for certain manufacturing tolerances.

To form the interstices 21 between the adjacent mixing elements 17 of the first shaft 15, there are provided spacers 18, which have a smaller radial extent than the mixing elements 17. Similarly, to form the interstices 22 between the adjacent mixing elements 19 of the second shaft 16, there are provided spacers 20, which have a smaller radial extent than the mixing elements 18. In the embodiment shown of the device 10, the spacers 18, 20 are configured in the form of discs, which can be pushed onto the respective shafts 15, 16. The spacers 18, 20 also fulfil the function of mixing elements. To ensure that the spacers 18, 20 rotate with their respective shafts 15, 16, a form-fit connection is realized by providing the spacers 18, 20 with a non-circular centre hole, e.g. a hole with a polygonal cross-section, and by providing the shafts 15, 16 with opposite cross-sections. To provide form-fit connections between the shafts 15, 16 and the mixing elements 17, 19, the mixing elements 17, 19 may also be provided with centre holes 17b, 19b with a corresponding non-circular cross-section, as can be seen in FIG. 6C and FIG. 6D. With such an embodiment, it is possible to assemble the device 10 by alternately fitting mixing elements 17, 19 and spacers 18, 20 onto the shafts 15, 16. With this design, individual mixing elements 17, 19 or spacers 18, 20 may also be exchanged.

FIGS. 6A to 6D show various embodiments of the mixing elements 17, 19. FIG. 6A shows a mixing element 17, 19 configured to have two blades. FIG. 6B shows a chamfer 17a, 19a of the mixing element 17, 19, whereby the mixing element 17, 19 may be circular disc-shaped or have blades. FIG. 6A shows a mixing element 17, 19 with four blades. FIG. 6D shows an eight-blade mixing element 17, 19. In FIGS. 6A to 6D the respective largest radial length R of the mixing elements 17, 19 is drawn. FIGS. 6C and 6D show the hexagonal centre holes 17b, 19b. The chamfer 17a, 19a on the periphery of the mixing elements 17, 19 shown in FIG. 6B serves to support the transport of the plastic melt from the melt inlet opening 13 to the melt outlet opening 14 and thus to ensure a defined dwell time. The chamfers 17a. 19a exert a slight propeller effect and thus propulsion on the viscous plastic melt. Also, the design of the mixing elements 17, 19 as blades and optionally an offset arrangement of the mixing elements 17, 19 configured as blades or a twisting of the blades supports a flow of the plastic melt between the melt inlet opening 13 and the melt outlet opening 14, especially with viscous plastic melts. FIGS. 8A, 8B, 8C show an arrangement of the mixing elements 17, 19 in the form of blades on the shaft 15, 16 in the form of a helix, in that the mixing elements 17, 19 are offset at an angle to each other.

FIGS. 7A to 7C show various cross-sectional shapes of the shafts 15, 16 used in the device 10 according to the invention for the form-fit connection to the oppositely configured centre holes 17b, 19b of the mixing elements 17, 19 and the centre holes of the spacers 18, 20, respectively. FIG. 7A shows the aforementioned hexagonal cross-sectional shape of the shaft 15, 16. FIG. 7B shows a splined shape of the shaft 15, 16. FIG. 7C shows a circular shaft 15, 16 with a longitudinal groove and a fitted key 25 inserted therein for producing a form-fit connection.

The greatest radial lengths R of the mixing elements 17, 19 are dimensioned in such a way that they have a distance T of 0.5 to 5 mm to the outer surface of the shaft 16, 15 opposite to them or, as shown in FIG. 5, to the outer surface of the spacers 20, 18 arranged on the shaft 16, 15 opposite to them when they engage in the interstices 22, 21. This will ensure that plastic melt adhering to the surfaces of the spacers 18, 20 or the shafts 15, 16 is also sheared off by the mixing elements 19, 17.

The motors M1, M2 may be controlled in such a way that they can rotate the first and second shafts 15, 16 at different speeds in the same direction or in opposite directions. Preferably, the motors M1, M2 are also reversible in their direction of rotation, whereby the first and second shafts 15, 16 are also reversible in their direction of rotation. It is possible to realise an operation of the device 10, in which initially only one of the two shafts 15, 16 is reversed in its direction of rotation, and then later the second shaft 16, 15 is reversed in its direction of rotation. This may be repeated periodically.

Furthermore, in the present device 10 it is provided that the first or/and the second shaft 15, 16 are/is axially displaceable, i.e. in the direction of their axis of rotation, the displacement preferably taking place in a pulsating manner. Such an axial displacement of the shafts 15, 16 may be realized, for example, by means of link guides, cam drives or hydraulic/pneumatic cylinders. A common axial displacement of the two shafts 15, 16 serves to scrape off the front-face inner walls of the housing 12. A slight axial displacement of one shaft 15, 16 or an opposite displacement of the two shafts 15, 16 is provided to change the gap widths in the interstices 21, 22.

FIGS. 9 and 10 show a further embodiment of the device 10 according to the invention for treating melts of thermoplastic materials. This embodiment differs from the embodiment shown in FIGS. 2 and 3 essentially only in that there is configured a screw conveyor 23 in the bottom region inside the housing 12 between the mixing elements 17 of the first shaft 15 and the mixing elements 19 of the second shaft 16, such that the plastic melt accumulated in the bottom region inside the housing 12 is also discharged from the housing 12 in a defined dwell time. In FIG. 9 and FIG. 10 the screw conveyor 23 is shown as a single screw. Alternatively, the twin screw shown in FIG. 11 may also be used. This screw conveyor may be driven by a third motor M3 and may also be used to discharge 14a the plastic melt from the reactor 10.

Using the presented device 10 a method for heat treatment, preferably decontamination, of melts of thermoplastic materials may be carried out, which is achieved by allowing the melt to remain in the heat treatment device for a heat treatment time of 1-120 min at a heat treatment temperature above the melt temperature of the plastic to be treated and optionally a vacuum between 0.1 and 900 mbar, preferably between 1 and 10 mbar. The heat treatment may be carried out in the form of a melt phase polycondensation, whereby polycondensates such as PET, PA or PC are treated, and whereby the viscosity of the polycondensate is changed by adjusting the treatment temperature, the pressure and the dwell time or their progressions.

Further, the heat treatment may be such that the plastic melt is continuously transported from the melt inlet opening 13 to the melt outlet opening 14 on a first in, first out basis. Although not shown in the drawings, the housing 12 may have additional inlets, through which plastic melts having different properties and/or from other sources are fed into the interior of the housing 12. In operation, the housing 12 is not completely filled with plastic melt, but may rather be more than half filled with plastic melt.

1-18. (canceled)

19. A device for treating melts of thermoplastic materials, comprising:
a housing with a melt inlet opening, a melt outlet opening and a withdrawal opening for volatile components of the plastic melt, comprising a first rotatably driven shaft and a second rotatably driven shaft,
wherein a plurality of mixing elements are arranged on each shaft axially spaced from one another and rotating with the shaft,
wherein the mixing elements of the first shaft are axially offset from the mixing elements of the second shaft in such a way that the mixing elements of the first shaft face interstices formed between the axially spaced mixing elements of the second shaft and the mixing elements of the second shaft are axially spaced from each other, and the mixing elements of the second shaft are axially offset from the mixing elements of the first shaft in such a way that the mixing elements of the second shaft face interstices formed between the axially spaced mixing elements of the first shaft,
wherein a distance (A) between the first and second shafts and a greatest radial length (R) of the mixing elements are dimensioned in a way such that the mixing elements engage in the spaces opposite to them,
wherein the first or/and the second shaft are/is axially displaceable, and
wherein the displacement is preferably realized in a pulsating manner.

20. A device according to claim 19, wherein the axial thicknesses (D) of the mixing elements are dimensioned in such a way that they form a gap (S) having a width of between 0.5 and 5 mm when engaging in the interstices with the mixing elements defining these interstices.

21. A device according to claim 19, wherein the axial distances (G) of the mixing elements are defined by the arrangement of spacers between the mixing elements, wherein the spacers have a smaller radial extent than the mixing elements.

22. A device according to claim 21, wherein the spacers are discs, which may be pushed onto the respective shaft.

23. A device according to claim 19, wherein the greatest radial lengths (R) of the mixing elements are dimensioned in such a way that, when they engage in the interstices, they are at a distance of 0.5 to 5 mm from the outer surface of the shaft opposite to them or from the outer surface of spacers arranged on the opposite shaft.

24. A device according to claim 19, wherein the first and second shafts are aligned in parallel to one another.

25. A device according to claim 19, wherein the mixing elements are configured as blade elements having at least two blades, or as discs.

26. A device according to claim 19, wherein the mixing elements comprise chamfers on their peripheries.

27. A device according to claim 19, wherein the first and second shafts are rotatable in the same direction or in opposite directions at different speeds.

28. A device according to claim 19, wherein the first and/or the second shaft are switchable in their direction of rotation.

29. A device according to claim 19, wherein a screw conveyor is formed in the lower part inside the housing.

30. A device according to claim 19, wherein the housing and/or at least one of the shafts are temperature controllable.

31. A device according to claim 19, wherein the mixing elements are encased in their enveloping form by the housing.

32. A device according to claim 31, wherein a gap of between 0.5 and 5 mm is formed between the inner wall of the housing and the enveloping forms of the mixing elements.

33. A method for heat treatment of melts of thermoplastic materials, comprising providing a heat treatment device having a housing with a melt inlet opening, a melt outlet opening and a withdrawal opening, connectible to a vacuum, for volatile components of the plastic melt according to claim 19, introducing the melt into the heat treatment apparatus and allowing the melt to remain in the heat treatment apparatus for a heat treatment time of 1-120 min at a heat treatment temperature above the melt temperature of the plastic to be treated.

34. A method for heat treatment according to claim 33, c allowing the melt to remain in the heat treatment device under a vacuum of between 0.1 and 900 mbar, preferably between 1 and 10 mbar.

35. A method for heat treatment according to claim 34, wherein a gas or air flow is additionally introduced into the housing.
